(19) United States
(12) Patent Application Publication
(10) Pub. No.: US 2002/0073012 A1
(43) Pub. Date: Jun. 13, 2002

(54) Vehicle service repair network

(76) Inventors: Michael J. Lowell, Dana Point, CA (US); Donald P. Wolfe, Irvine, CA (US); Doug Nottage, Irvine, CA (US); Michael Blair, Sugar Land, TX (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/736,670

(22) Filed: Dec. 13, 2000

(51) Int. Cl. G06F 17/60

(52) U.S. Cl. 705/37; 705/26

(57) ABSTRACT

A system and method are described that allow a customer to shop on-line for service businesses that will repair a vehicle. The system provides an input screen that captures information relating to the vehicle needing service and transmits that data to service businesses. The service businesses respond to the transmitted data by forwarding an estimate for the repair work to the system. A custom Internet page that displays all of the estimates is developed by the system and a link to that page is emailed to the customer.

### BACKGROUND OF THE INVENTION

1. Field of the Invention

The system relates generally to systems and methods for conducting transactions using networked computers. More particularly, the invention relates to a system and method for finding, selecting and scheduling various types of vehicle services on-line.

2. Description of the Related Art

Consumers typically order services for their vehicles by opening a telephone book and sifting through numerous listings of repair businesses in order to find the right one. The consumer looks for a business that will service the specific type of car; one that provides the type of service the car needs, and one that is located in the geographical area desired by the consumer. This can be a laborious process as there are an abundant number of repair service businesses listed in most telephone books. In addition, most of these listings have limited information regarding the repair business' qualifications and specialties. Furthermore, while the listings provide street addresses of these businesses, this can often be of limited value if the consumer does not know the location of the street given in the listing.

Alternatively, the consumer may return to the vehicle dealer who sold them the car. However, vehicle service centers at dealerships can be very expensive in comparison to other service businesses. Therefore, the consumer is left with the choice of selecting an expensive dealership repair facility or searching extensive telephone book listings trying to select an appropriate repair service business.

Recently, through the Internet and World Wide Web (“WWW”), vehicle repair businesses have been able to advertise on websites and through various search engines. These search engines provide a number of directories containing various categories of vehicle services. Some of these on-line services even provide listings of service providers with respect to a certain location. Unfortunately, the consumer is still left to call the repair business, find out if an estimate is available over the phone, describe the problem, and schedule an appointment. Moreover, this process must be repeated for each suitable repair business in the area. This is very time consuming and can be frustrating for the consumer.

What is needed is a process and system that will allow a consumer to simply and efficiently order services for their vehicle. Ideally, this process should also return a list of available repair and service businesses in the consumer's area that are qualified to perform the desired service.

### SUMMARY OF THE INVENTION

One embodiment of the invention is an online system for ordering vehicle services. This embodiment includes: an input module adapted to receive a service request order from a customer; a processing module adapted to determine a plurality of service businesses that are geographically near the customer; a transmission module adapted to electronically transmit the service request order to the plurality of service businesses; and an estimation module adapted to receive service estimates from the plurality of service businesses.

Another embodiment of the invention is a method for electronically ordering vehicle services. The method includes: receiving a service request order from a customer; determining a plurality of service businesses that are geographically near the customer; electronically transmitting the service request order to the plurality of service businesses; and receiving service estimates from the plurality of service businesses.

### BRIEF DESCRIPTION OF THE DRAWINGS

FIG. 1 is a block diagram illustrating an embodiment of the overall network architecture of the invention.

FIG. 2 is a flow chart illustrating a vehicle service request process according to one embodiment of the invention.

FIG. 3 is a flow chart illustrating a process for providing information regarding the car, the type of service desired and the preferred geographical area for the service according to one embodiment of the invention.

FIG. 4 is a flow chart illustrating a process for responding to service request orders (“SROs”) that includes locating service providers and generating specific SRO forms for those service providers, according to one embodiment of the invention.

FIG. 5 is a flow chart illustrating a process for transmitting SROs to service providers and tracking response time according to one embodiment of the invention.

FIG. 6 is a flow chart illustrating a process for receiving the SRO, generating a service estimate and transmitting that estimate, according to one embodiment of the invention.

FIG. 7 is a flow chart illustrating a process for generating a universal resource locator (URL) containing service provider responses for customer to select from while monitoring for customer's visiting of site, according to one embodiment of the invention.

FIG. 8 is a flowchart illustrating a process for the generation of a telephone reminder to the customer to visit the URL, according to one embodiment of the invention.

FIG. 9 is a flowchart illustrating a process for a customer to select a service provider from the URL and schedule service from that service provider, according to one embodiment of the invention.

FIG. 10 is a flowchart illustrating a process for a service provider to schedule a service visit, according to one embodiment of the invention.

FIG. 11 is a flowchart illustrating a process for a generating a customer satisfaction survey, according to one embodiment of the invention.

### DETAILED DESCRIPTION

Embodiments of the present invention relate to a real time on-line system for scheduling vehicle services. Utilizing the system described below, a consumer can access an Internet server and describe the type of service necessary for their vehicle by filling in a web page questionnaire. Based on the consumer's answers, the system determines the type of service needed and the locations of local repair facilities that handle such repairs.

In one embodiment, once the consumer has completed the questionnaire, the system electronically forwards SROs to the local repair facilities so that they can bid on performing the requested services. The repair facilities return electronic bids to the consumer computer, which can then select the most desirable bid. In one embodiment, the consumer makes an on-line reservation with the repair facility to have the services performed.

In one embodiment, an on-line service provider system includes a service center. The service center provides a network connection to which one or more service providers and customers, as well as other network devices may be advantageously networked. The service center may advantageously utilize a web server to provide a network connection over a public network such as the World Wide Web (“WWW”) or a private network. The service center preferably includes information regarding one or more service providers and helps customers locate and schedule vehicle services.

In another embodiment, the system provides a method for selecting and scheduling vehicle services by a customer. The system includes a network that connects a service center with one or more services providers and customers. This system may employ a public network such as the Internet or a private data network.

In another embodiment, the present invention provides an on-line service system that facilitates the location of lube, oil and filter service providers by connecting customers and one or more service providers together through a computer network. In this embodiment, the service center assists the customer in selecting a service provider for lube, oil and filter service, as well as help the customer schedule such service. In another embodiment, a method for facilitating selection and scheduling of such service is accomplished by providing a network connecting a service center to customers and to one or more service providers.

In another embodiment of the invention, a computerized maintenance system is provided that facilitates a customer in selecting a service provider and scheduling upkeep and maintenance of a vehicle. This system may advantageously utilize a public or private network to connect a service center to customers and one or more service providers, and may additionally remind the customer of upcoming maintenance that should be scheduled. Such reminders may be used to meet warranty requirements and major tune-up milestones for a specific vehicle. This system preferably employs a means of storing data on various vehicles regarding maintenance requirements and recommendations by car manufacturers. Another embodiment of this invention is a method for facilitating the accomplishment of such warranty and tune-up maintenance. This method is accomplished by providing a public or private network to connect customers and service providers with a service center.

Another embodiment of the present invention includes a system for providing vehicle recall information to a customer. The system preferably utilizes a public or private network to inform customers of recall information regarding their vehicle. The system preferably provides a network connection to connect a service center to a customer. The customer uses an HTML interface to provide information to the service center regarding their car to which the service center can respond, periodically or spontaneously, by providing information on recall items for the car. Additionally, the service center may provide a selection of service providers that can replace the recalled item and facilitate the customer in scheduling such recall service. In another embodiment, a method for providing recall information is accomplished by providing a network connection between a customer and a service center. As before, in this method the service center provides notice of recalled items through the implementation of a public or private network.

Another embodiment of the present invention is a system for providing roadside assistance that uses a public or private network connection between a service center, a customer and one or more service providers. The system allows customers to request information on roadside assistance providers, to join a roadside assistance membership plan, or to order roadside assistance service through a dial-up or wireless link to the Internet. An embodiment of this invention also preferably includes a method for facilitating a customer's selection of roadside assistance plans or service. This method preferably incorporates a public or private network to connect a service center to a customer and one or more roadside assistance providers and facilitates the selection of such plans or assistance by the customer.

Yet other embodiments of this invention include systems and methods for selecting and scheduling tire and brake service and replacement. The system and method utilize a network connection which connects a service center to a customer and one or more tire or brake service providers. The system and method advantageously utilize a public or private network to connect a service center to a customer and one or more service providers and facilitate the customer in selecting a service provider and scheduling service.

Other embodiments of the present invention include a system and method for assisting a customer in performing maintenance on the customer's own car. The connection preferably includes a data source, such as a database containing published repair information and specifications, from which the customer may receive repair information on specific types of vehicles and repairs.

These systems and methods may include any type of electronically connected group of computers, processors or microprocessors including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). It should be realized that computing devices may be desktop, server, portable, hand-held, set-top, or any other desired type of configuration. As used herein, an Internet includes network variations such as public internet, a private internet, a secure internet, a private network, a public network, a value-added network, an intranet, and the like.

The microprocessors may be any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

The methods and systems described may employ computer modules as described below to perform the functions necessary to accomplish the goals of the system. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

A customer may connect to the service center via a network connection such as the Internet, provide information about the car and request information related to a certain type of service. The customer enters information about what type of service is to be performed by, for example, selecting from menus and sub-menus, through a written description of the customer's situation, or through a question and answer process. The service center may, through connections to a source of information, such as a database, or through other connections to service providers, to provide information to the customer on available service providers of the service in the customer's area. Also, the service center preferably returns information on recommended maintenance schedules for the customer's type of car. The customer can select from a variety of services available including, but not limited to: general repair services; lube, oil and filter services; warranty and tune-up information and services; recall notices; roadside assistance plans and services; tires and brake repair and services; and information for self-repairs performed by the customer.

Through network connections with the service providers, the service center makes scheduling information available to the customer for the services requested. In one embodiment of this invention, the customer requests estimates for services that the service providers can provide on-line to the customer via a network connection with the service center.

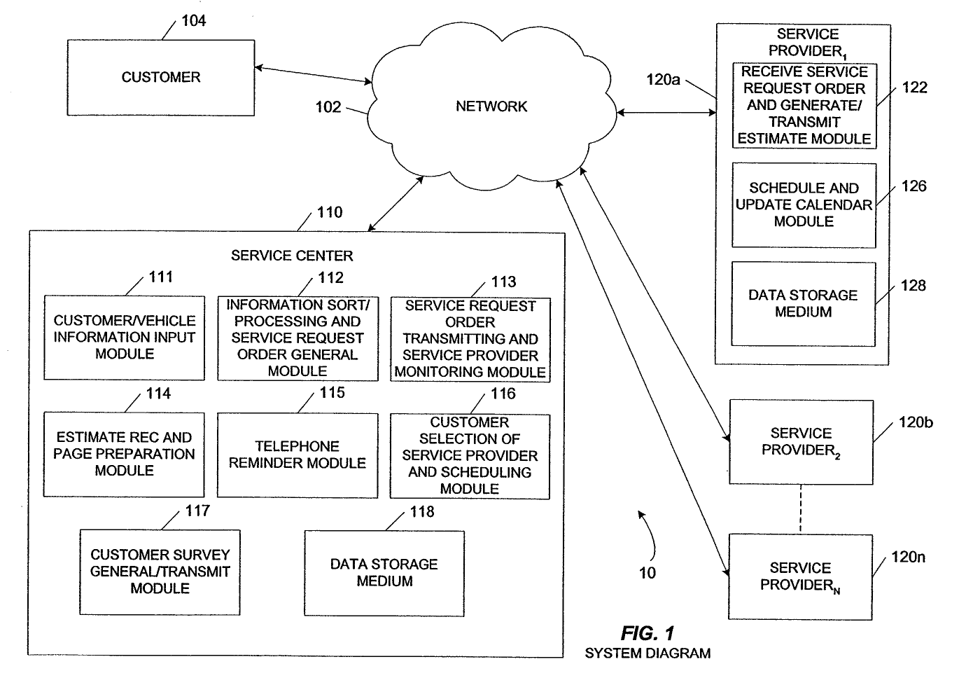

One network architecture suitable for use with one embodiment of the invention is indicated generally by a system 10 in FIG. 1. The system 10 includes a network 102, which represents a computer wide area network as previously described, providing network connections between the attached devices. The system 10 further includes an online service center system 110 which is preferably an internet server and is connected to one or more service provider terminals 120a-n and one or more customer terminals 104 through the network 102. The on-line service center system 110, the customer terminals 104, and the service provider terminals 120a-n are connected to the network 102 directly or through a connection device such as a router or other similar device.

In one embodiment, the system 10 conforms to the Transmission Control Protocol/Internet Protocol (TCP/IP) industry standard. In other embodiments, the system 10 conforms to other network standards, including, but not limited to, the International Standards Organization's Open Systems Interconnection, IBM's SNA®, Novell's Netware®, and Banyon VINES®, that facilitate communication between the attached devices.

As illustrated in FIG. 1, the on-line service center system 110 includes: a customer/vehicle information input module 111, an information sorting/processing and SRO generation module 112, an SRO transmittal and service provider monitoring module 113, an estimating receipt and URL preparation module 114, a telephone reminder module 115, a service provider and scheduling module 116, a customer survey generation and transmission module 117 and one or more data storage mediums 118. Those of ordinary skill in the art will realize that the data storage mediums 118 may advantageously be contained within computer(s) comprising the service center system 110.

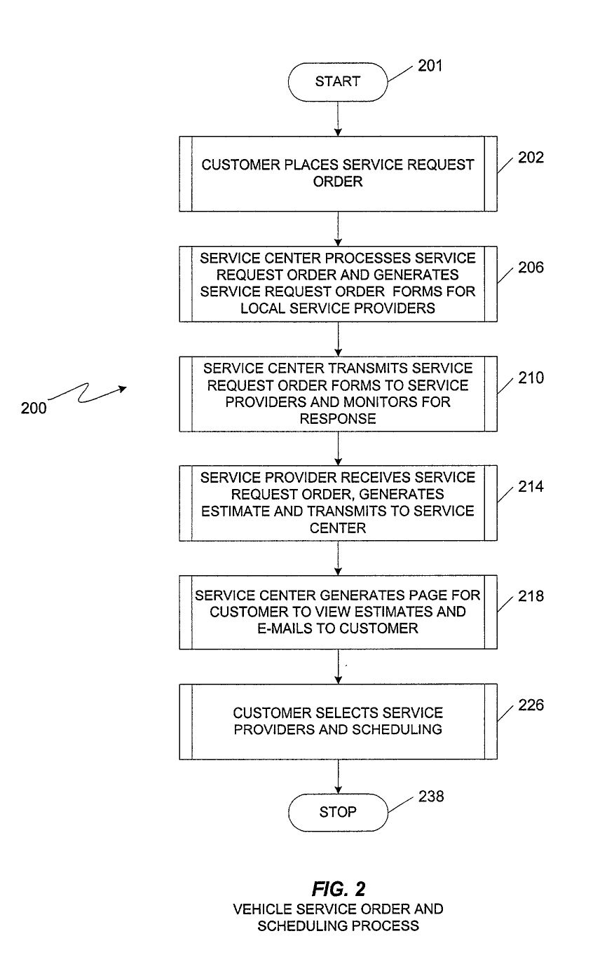

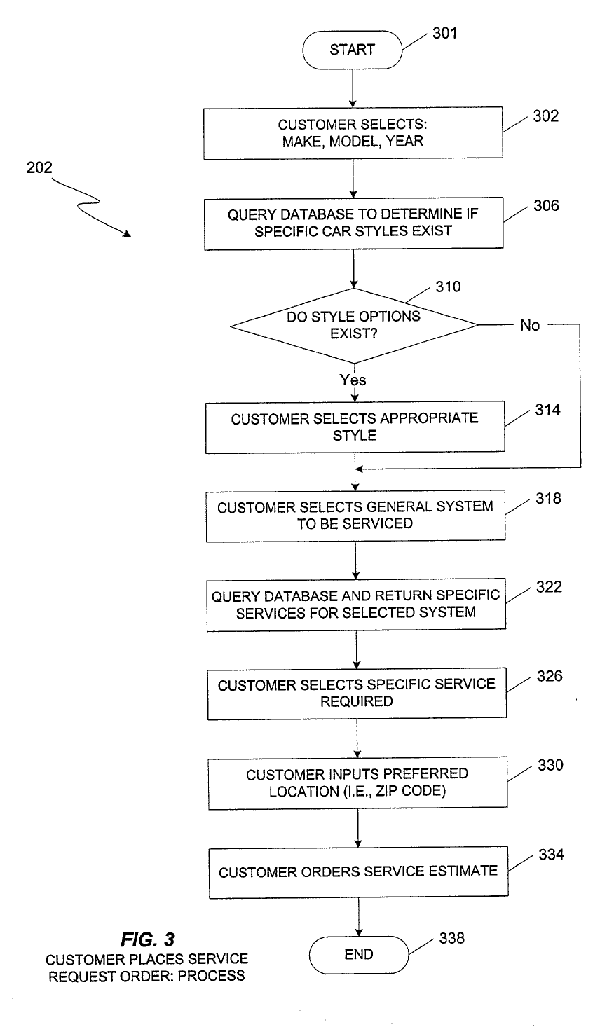

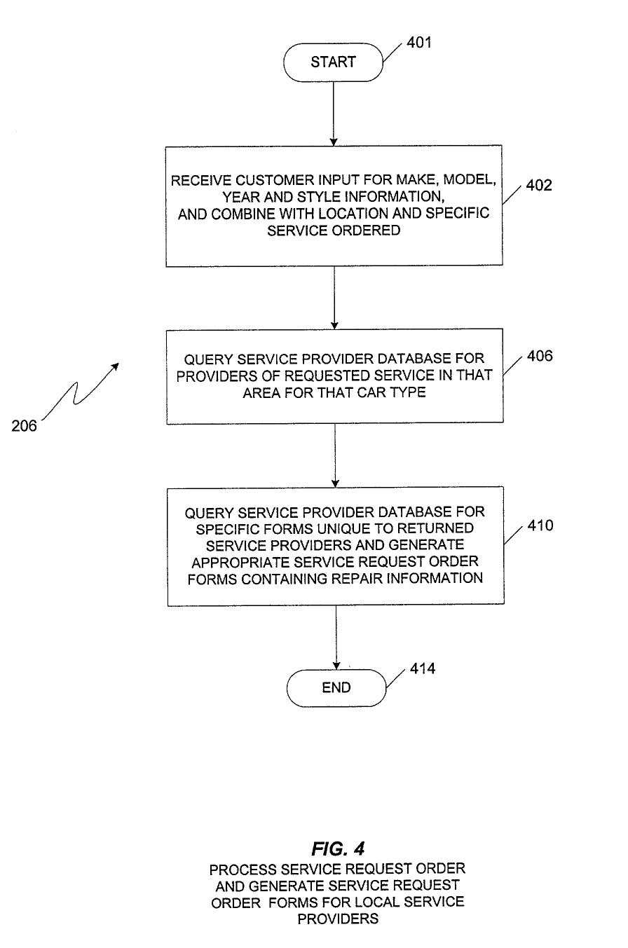

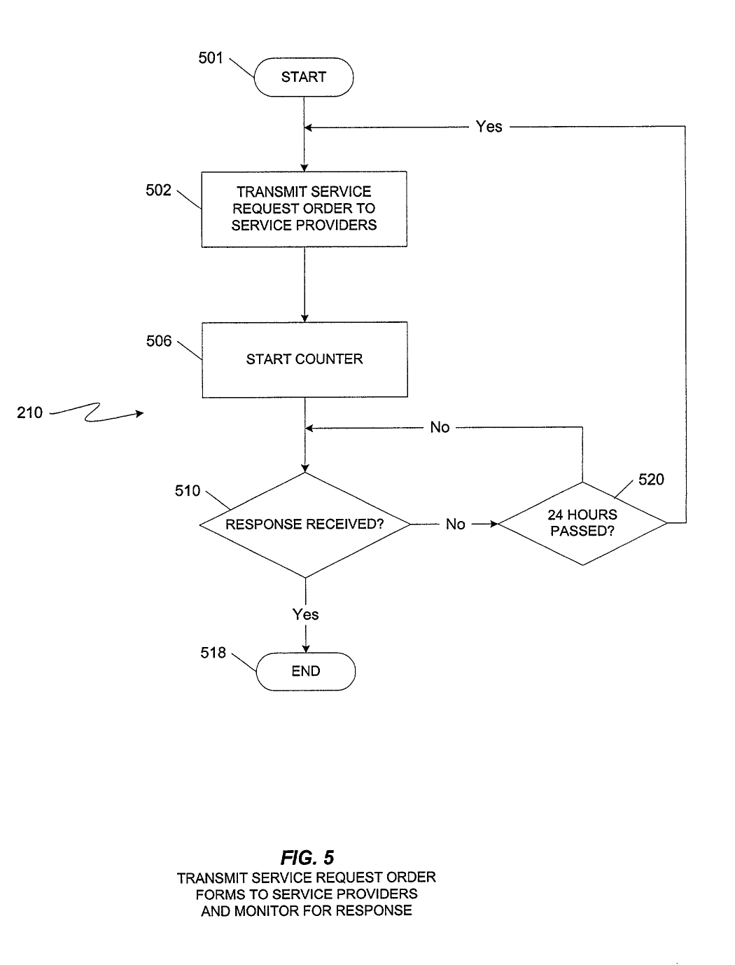

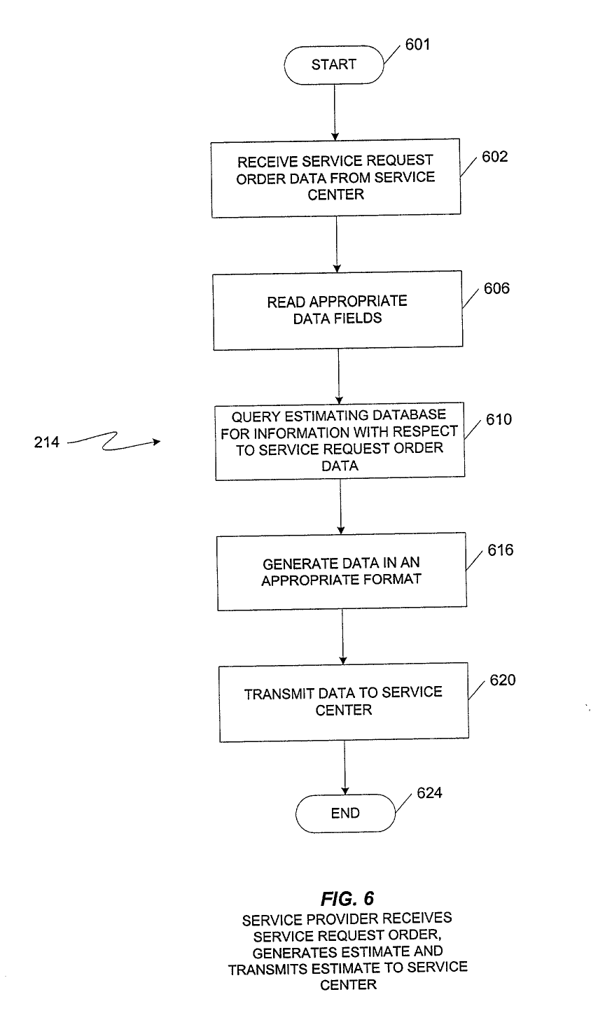

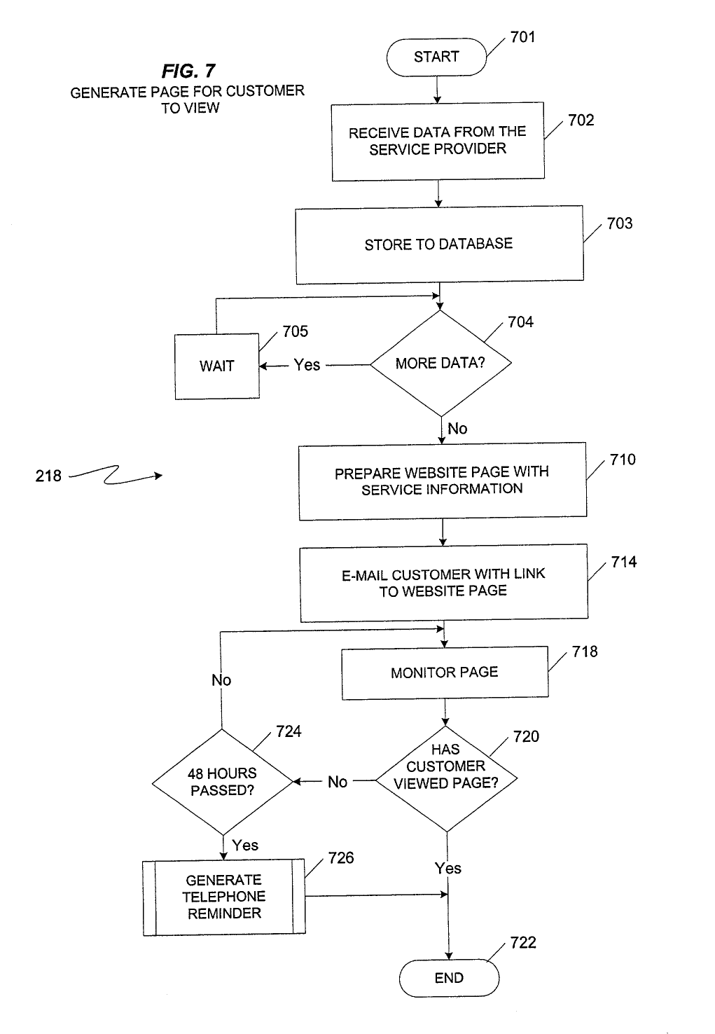

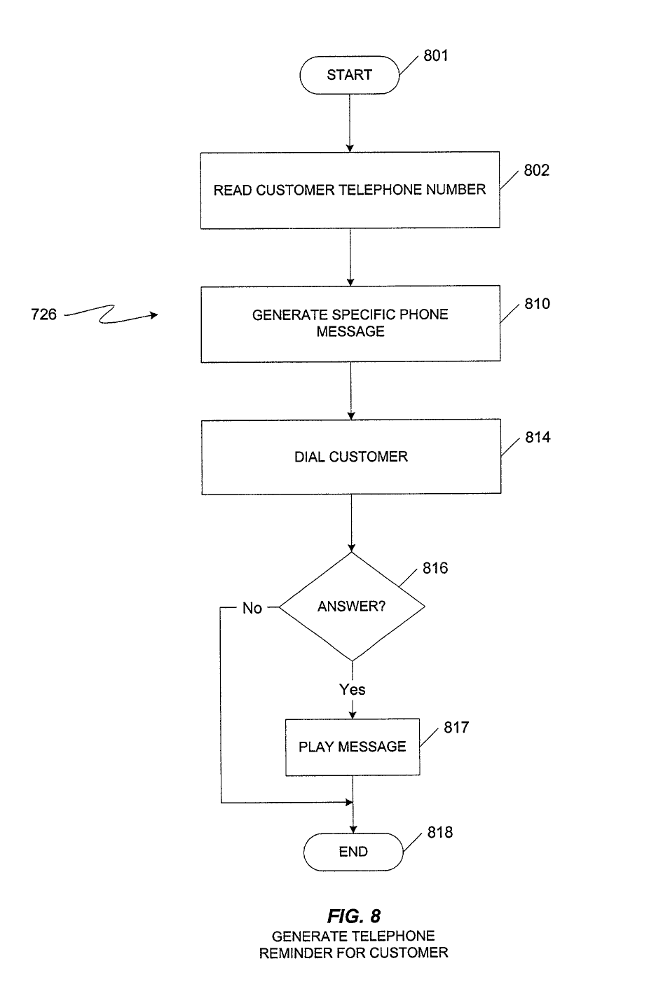

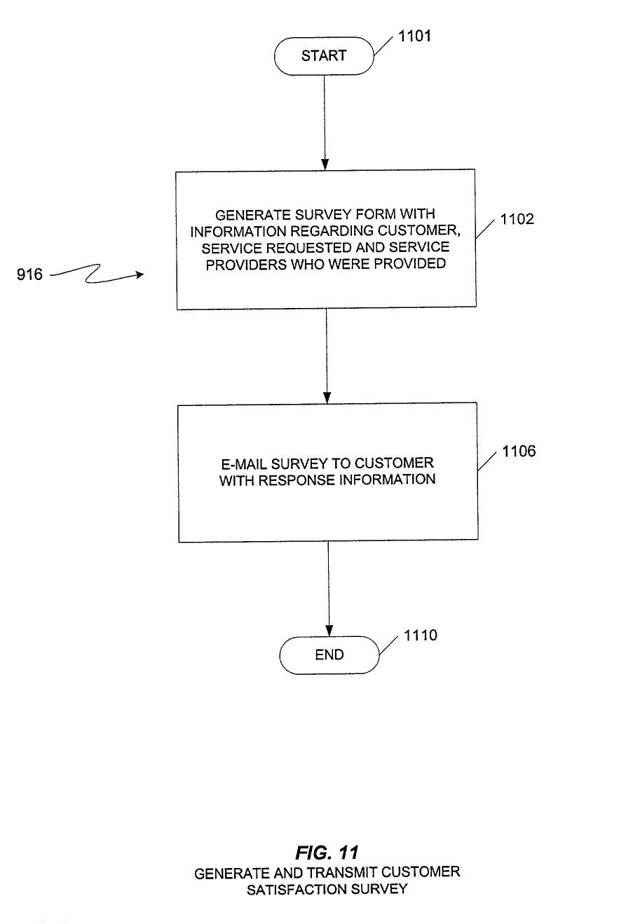

The customer/vehicle information input module 111 comprises the process 202 described below in FIGS. 2 and 3. The information sorting/processing and SRO generation module 112 comprises the process 206 described below in FIGS. 2 and 4. The SRO transmittal and service provider monitoring module 113 comprises the process 210 described below in FIGS. 2 and 5. The process state 214 of generating an estimate and transmitting it to a service center is illustrated in FIGS. 2 and 6. The estimating receipt and URL preparation module 114 comprises the process 218 described below in FIGS. 2 and 7. The telephone reminder module 115 comprises the process 222 described below in FIGS. 2 and 8. The customer selection of service provider and scheduling module 116 comprises the process 226 described below in FIGS. 2, 9 and 10. The customer survey generation and transmission module 117 comprises the process 234 described below in FIGS. 2 and 11.

The computers and terminals may be uniprocessor or multiprocessor machines. Additionally, these computers may include an addressable storage medium such as, by way of example, random access memory, and may further include a non-volatile storage medium such as, by way of example, a magnetic or an optical disk. The addressable storage medium and/or the non-volatile storage medium may advantageously contain a specific physical substrate configuration such as a computer program, representing data and instructions which cause the computer to operate in a specific and predefined manner as described herein.

The network 102 connects to the customer 104 or service provider computers 120 by use of a modem or through a network interface card. As illustrated, customers utilize such devices to remotely access the on-line service center system 110 via the network 102. The terms “customer terminal” and “service provider terminal” are intended to include any device useful for providing access to the on-line service center system 110. Moreover, the same device may function as both a customer terminal and a service provider terminal. In one embodiment, the service provider terminal 120 includes: an SRO receiving and estimate generating and transmitting module 122, a service scheduling and calendar updating module 126, and a data storage medium 128 such as a data base, among other items. The SRO receiving and estimate generating and transmitting module 122 comprises the process 214 and is described below in FIG. 2. The service scheduling and calendar updating module 126 includes the process 230 and is described below in FIG. 2.

In one embodiment, the storage medium 118 is configured as a database from which information can be stored, updated, and retrieved. In one embodiment, the database is a System Query Language (SQL) database that accesses information from a SQL server. The information may advantageously include one or more of the following: customer information, service provider information, geographical location data, and service provider response information; in addition to other types of information. The on-line service center system programs may provide access to the information stored on the storage medium 118.

Although particular computer systems and network components are shown, those of ordinary skill in the art will appreciate that the system also works with a variety of other networks and components.

FIG. 2 is a flow chart generally illustrating a process 200 of a customer submitting a SRO to the service center 110 and entering service information for a vehicle. The subsequent states may advantageously be implemented as one or more program modules configured to reside on one or more storage mediums and executed on one or more processors residing in one or more centers or terminals. The process 200 starts at a state 201 and then moves to a process state 202 wherein a customer utilizes a web browser executing on the customer terminal 104 to access a login page at the service center 110. The customer submits a login identification through the login web page and then accesses and submits an on-line SRO. The order preferably includes information regarding the vehicle, the customer and the desired geographical location for the service. Such a login process may be forgone in an alternate embodiment, whereby the customer directly accesses the SRO. The process 202 is explained more completely in FIG. 3.

The process 200 then moves to a process state 206 wherein the service center 110 processes the information provided by the customer and generates SROs for the service providers in the area indicated by the customer. Once the service center has processed the SRO, the process 200 moves to a process state 210 wherein the service center 110 transmits the SRO to a plurality of the appropriate service providers in the preferred area. Preferably, the service center begins monitoring the service provider to ensure that a timely response is provided. If no such response is forthcoming within a predetermined period of time, the service center 110 may take actions to prompt a response from the service provider. A predetermined period of time can be, for example, 4, 8, 12, 24, 36 or 48 hours. Such actions may include repeating the transmittal of the SRO. This process 210 is explained more completely with reference to FIG. 4. The process 200 then moves to a process state 214 wherein the service provider terminal 120 receives the SRO from the service provider. Following receipt of the SRO, the service provider generates a cost estimate from the information provided in the SRO and transmits this cost estimate to the service center 110. This is explained more completely in FIG. 5.

The process 200 then moves to a process state 218 wherein the service center 110 receives the cost estimate from all of the service providers that were contacted. With this cost estimate and the associated customer information, the service center 110 creates a unique Internet page with information from the service providers who have returned estimates of the work. The network address of the page may also include user selected commands which begin an on-line service scheduling process through the service center. The service center 110 then sends the network address of the page to the customer by electronic means, such as e-mail, or by other means such as telephone messaging, or conventional mail. After the network address is transmitted to the customer, the service center begins monitoring the unique address to determine if the customer has visited it. This is explained more completely in FIG. 6. At process state 222, the service center takes an action if 48 hours have passed and if the customer has not visited the page of the network address. If no page views were made by the customer, an automated telephone message is generated and a call is placed to the customer to play the message.

Once the customer views the page, the process 200 moves to a process state 226 where the service provider and information regarding the service provider is located. The customer then elects to select a service provider from the plurality displayed and begins a service scheduling process 230. At the process state 230 the service provider terminal 120 provides scheduling information via the network 102 and updates its scheduling information storage to reflect any new appointments that are scheduled by customers. The process 200 then moves to a process state 234 wherein a customer satisfaction survey is generated. The survey may be an interactive electronic form into which the customer enters responses to questions or enters ratings in various areas. Alternatively, the survey may be a general form for the customer to provide feedback and return to the service center 110.

FIG. 3 illustrates a process 202 wherein a customer enters information about a vehicle to be serviced. In this process, the customer also enters information about the type of service requested and the preferred location for the service to be performed. The process 200 then moves to a state 302 wherein the customer selects the make, model and year of their vehicle that needs servicing. The customer accomplishes this, for example, through a series of selection menus or by entering information into input areas on an HTML page. The customer may also be requested to select the appropriate style of the model of car as well, as illustrated by the movement of process 202 to a state 310.

The process 202 begins at a start state 301 and then moves to a state 302 wherein a customer selects a make, model and year of a vehicle in need of servicing. Once the customer has selected or entered the make, model and year of the vehicle, the process 202 moves to a state 306 wherein the module 111 queries a vehicle database to determine if various car styles exist for the type of vehicle entered at the state 302. A determination is then made at a decision state 310 whether other style options exist for the selected vehicle. If other styles do exist, the process 202 moves to a state 314 wherein the customer selects the appropriate style vehicle that they own. However, if other styles do not exist, the process 202 skips state 314 and moves directly to state 318 wherein the customer is allowed to select the general system or part of their car that requires servicing.

Once the general system to be serviced, such as transmission, engine, wheels, tune-up, windshield and any other aspect of the car, has been selected the process 202 moves to a state 322 wherein a database of vehicle components is queried to return the specific services available for the selected system. For example, if the selected system is the windshield, the services might be to replace the windshield or repair the windshield.

Once the selected services have been queried and returned to the customer, the process 202 moves to a state 326 wherein the customer can select a specific service from a generated list or Internet page that is provided by the system in response to the previous data entered by the customer. The process 202 then moves to a state 330 wherein the customer provides their location, such as zip code, so that the system can determine service providers in their local area. The process 202 then moves to a state 334 wherein the customer orders a service estimate from the system prompt. The process 202 then terminates at an end state 338.

Referring now to FIG. 4, the process 206 of processing SROs and generating SRO forms for local service providers is explained. The process 206 begins at a start state 401 and then moves to a state 402 wherein the service center system 110 and module 112 sample the customer input based on the make, model, year, style and specific service requested and transmit it to the service center 110. Once this information has been received, a database query is made at a state 406 for service providers that work on the type of vehicle and type of service requested by the customer. This query is made to a database of service providers and the type of vehicles and services they perform.

The process 206 then moves to a state 410 wherein the service provider database is queried for specific formats used for each service provider so that data can be sent in the appropriate form for their computer systems. For example, a service provider database might have a list of XML formats that are appropriate for each service provider. Thus, the system 110 can provide data to each service provider in a format that is readable by their computer systems. At the state 410, the appropriate SRO forms and data formats are generated including the customer's repair information so that they can be forwarded to service providers in the near vicinity of the customer's location. The process 206 then terminates at an end state 414.

Referring now to FIG. 5, the process 210 of transmitting a SRO to the service providers and monitoring a response is illustrated. The process 210 begins at a start state 501 and then moves to a state 502 wherein an electronic SRO is transmitted from the service center 110 using the module 113 to one or more service providers. It should be realized that each service provider would receive a SRO in an electronic format that is compatible with their systems. Thus, the entire ordering process can be managed via computer. Once the SRO has been transmitted, a counter is started at a state 506 and then the process 210 moves to a decision state 510 to determine whether a response to the SRO has been received from the service provider. If a response has been received, the process 210 terminates at an end state 518.

If a response was not received from the service provider at the decision state 510, the process 210 moves to a decision state 520 to determine whether 24 hours has passed. Of course, it should be realized that any number of minutes, hours or days could be similarly implemented. If a determination is made at the decision state 520 that 24 hours has not passed, the process 210 returns to the decision state 510 to determine whether a response to the transmitted SRO has been received. However, if a determination is made at the decision state 520 that more than 24 hours has passed, the process 210 returns to the state 502 wherein the SRO is retransmitted to the service provider.

Referring now to FIG. 6, the process 214 of a service provider receiving a SRO, generating an estimate and transmitting that estimate to a service center is illustrated. The process 214 begins at a start state 601 and then moves to a state 602 wherein the SRO data is received from the service center. As discussed previously, the data might be in a popular format such as XML. Once the SRO data has been received at the state 602, the process 214 moves to a state 606 wherein the service center computer system reads the appropriate data fields from the transmitted information. The process 214 then moves to a state 610 wherein an estimation database is queried for information relating to the price of the service requested by the customer. Once a cost estimate has been prepared at the state 610, the process 214 moves to a state 616 wherein the cost estimate is prepared in an appropriate format for transmission back to the service center computer 110. It should be realized that the appropriate format is an XML format that is readable by the service center system.

The process 214 then moves to a state 620 wherein the data generated at the state 616 is transmitted through the Internet to the service center. The process 214 then terminates at an end state 624.

Referring now to FIG. 7, the process 218 of generating a web page for a customer to view is explained. The process 218 begins at a start state 701 and then moves to a state 702 wherein the data transmitted by the service provider is received by the service center. The process 218 then moves to a state 703 wherein the received data is stored to a database. A determination is then made at a decision state 704 whether more data is being transmitted by other service providers to the service center. If a determination is made that more data still needs to be received from other service providers, the process 218 moves to a state 704 wherein it waits a predetermined time before re-evaluating whether more data needs to be received.

Once a determination is made at the decision state 704 that no more data needs to be received from additional service providers, the process 218 moves to a state 710 wherein a website page is created with the service information from each of the various service providers. This page would link, for example, the names, addresses and prices for performing the service from each of the various service providers. Once the website page has been generated at the state 710, the process 218 moves to a state 714 wherein a link to the prepared page is e-mailed to the customer. The process 218 then moves to a state 718 wherein the generated web page is monitored by the service center system to determine if the customer has viewed this page or not. It should be realized that this monitoring can be provided by analysis of a log table within the service center server that lists the Internet pages that are viewed by customers. Once the log enters that the generated website page has been viewed, the process 218 will determine that the customer has accessed the generated page. It should be realized that each page is addressed with a unique identifier so that only customers having sent out SROs will be able to access a given page. In addition, log-in and user name rights can be assigned to the generated page so that the customer must log-in and provide a password to have access to the prices returned by the various service providers.

The process 218 then moves to a decision state 720 to determine whether the customer has viewed the generated page. If the customer has viewed the page, the process 218 terminates at an end state 722. However, if the customer has not viewed the page, the process 218 moves to a decision state 724 to determine whether 48 hours have passed since the time the page was generated. If 48 hours has not passed, the process 218 returns to the state 718 and monitors the generated page to wait for a customer view. However, if 48 hours have passed at the decision state 724, the process 218 moves to a process state 726 wherein a telephone reminder is generated by the system. This process is explained more completely with regard to FIG. 8. Once the telephone reminder has been generated at the state 726, the process terminates at the end state 722.

Referring now to FIG. 8, the process 726 of generating a telephone reminder is explained. The process 726 begins at a start state 801 and then moves to a state 802 wherein the customer telephone number is read from a database within the service center system 110. The process 726 then moves to a state 810 wherein a specific phone message is generated for the customer. The specific phone message might include, for example, a description of the service being requested, an invoice or order number or other information useful for reminding the customer to review their web page.

Once the phone message has been generated at the state 810, the process 726 moves to a state 814 wherein the customer's telephone number is dialed by the service center system. A determination is then made at a decision state 816 whether there was an answer to the telephone call. If an answer was made, the process 726 moves to a state 817 wherein the message is played. The process 726 then terminates at an end state 818. If a decision had been made at the decision state 816 that the telephone call was not answered, the process 726 moves directly to the end state 818 and does not play a message.

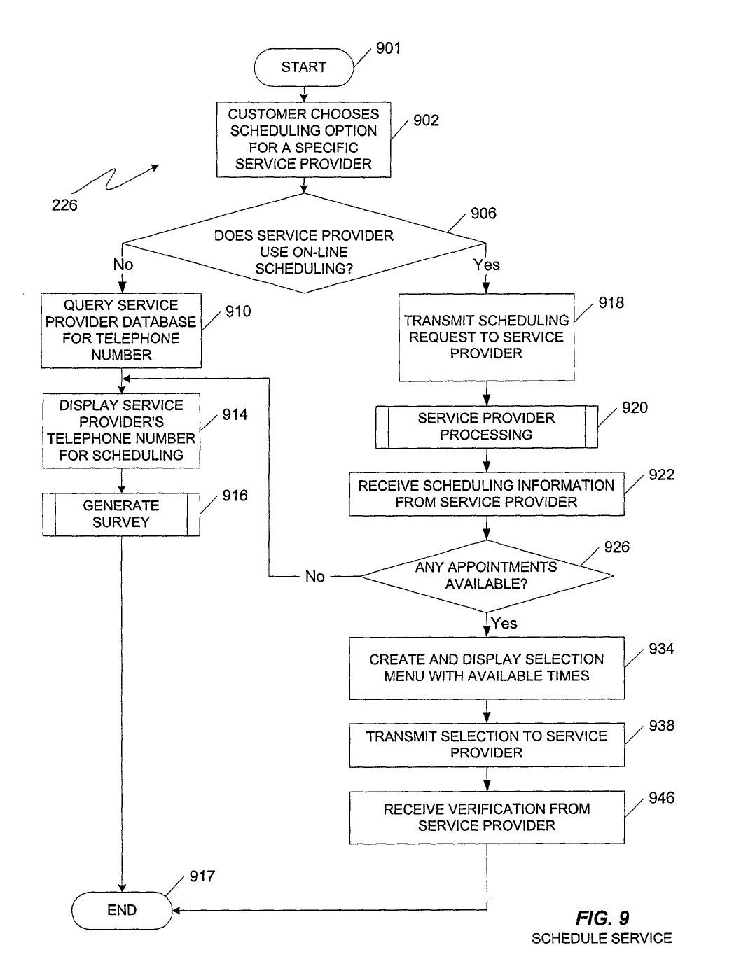

Referring now to FIG. 9, the process 226 of scheduling service with a service provider is illustrated. The process 226 begins at a start state 901 and then moves to a state 902 wherein the customer chooses a particular service provider to handle the requested service. Once the customer has chosen a particular service provider, a determination is made at a decision state 906 whether the service provider uses on-line scheduling or not. If the service provider does not use on-line scheduling, then the customer needs to schedule their service through alternate means, such as a telephone call. Thus, if a determination is made that the service provider does not use on-line scheduling, the process 226 moves to a state 910 wherein a service provider database is queried in order to return the telephone number of the service provider. The process 226 then moves to a state 914 wherein the service provider” telephone number is displayed to the customer. A survey is then generated at a process state 916 in order to determine how well the system meets the needs of the customer. The process 916 of generating customer surveys is explained more completely in FIG. 11. Once the survey has been generated, the process 226 terminates at an end state 917.

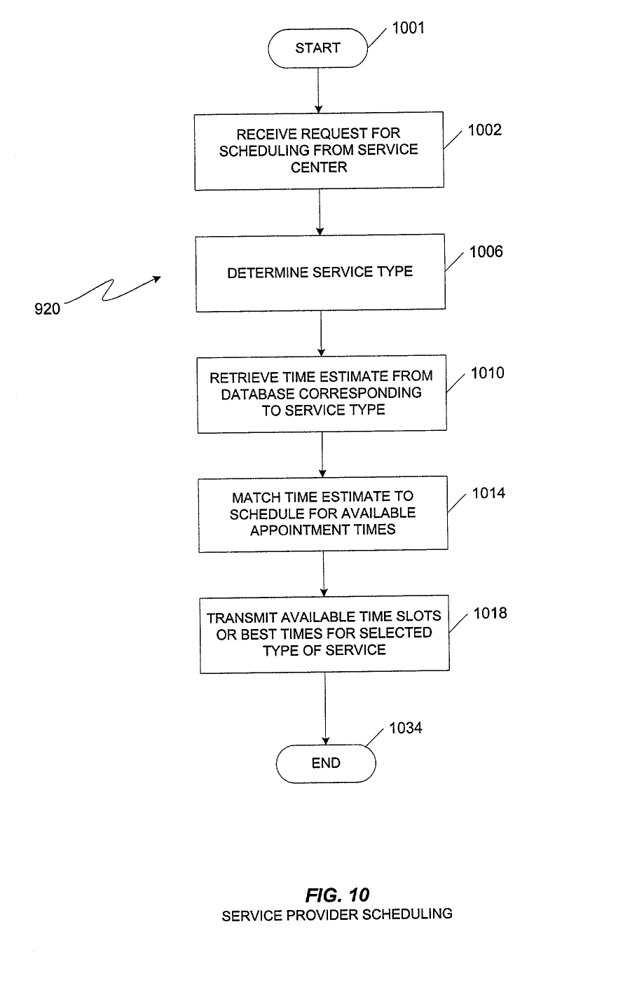

If a determination was made that the service provider did not use on-line scheduling, the process 226 moves to a state 918 wherein a scheduling request is electronically transmitted to the service provider. The process 226 then moves to a process state 920 wherein the service provider receives the transmitted service request and enters it into their computer system. The process 920 is explained more completely in FIG. 10. Once the service provider has completed processing at the state 920, the process 226 moves to a state 922 wherein the customer receives scheduling information back from the service provider. A determination is then made at a decision state 926 whether any appointments are available for the customer. If no appointments are available, the process 226 moves to the state 914 wherein the service provider's telephone number is displayed in order to provide a mechanism for the customer to contact the service provider.

However, if appointments are available, the process 226 moves to a state 934 wherein a selection menu is displayed to the customer on their web browser. This display provides a means for the customer to enter their designated service dates and times. It should be realized that the displayed schedule can include indicators of what dates and times are available, or not available, from the service provider. Thus, certain dates might be greyed out or marked in red to indicate that no more schedules are being accepted for that particular day. Once a menu has been displayed at the state 934, the process 226 moves to a state 938 wherein the selection is transmitted to the service provider. A verification of the scheduled appointment is then received by the customer at a state 946 and the process terminates at the end state 917.

Referring now to FIG. 10, the process 920 of a service provider generating a schedule is explained. The process 920 begins at a start state 1001 and then moves to a state 1002 wherein a SRO is received from the service center or customer. Once the SRO has been received, the process 920 moves to a state 1006 wherein the type of service being requested is determined. The process 920 then moves to a state 1010 wherein a time estimate for the selected service type is retrieved from a database. For example, replacing a windshield might require 1 hour wherein replacing a transmission might require 3 hours. By retrieving a time estimate from a database, the service provider can determine the length of time necessary to effectuate the repair.

The process 920 then moves to a state 1014 wherein the time estimate is matched to the service provider's repair schedule in order to determine available appointment times for the customer. Once the appointment times are determined, they are transmitted to the customer at a state 1018. The process 920 then terminates at an end state 1034.

Referring now to FIG. 11, the process 916 of generating and transmitting a customer satisfaction survey is illustrated. The process 916 begins at a start state 1101 and then moves to a state 1102 wherein a survey form is generated regarding the customer, service requested and service provider that undertook the repair. Once the form is generated at the state 1102, it is e-mailed or otherwise transmitted to the customer at a state 1106. Of course, it should be realized that a customer satisfaction survey could also be undertaken by generating an HTML web page with fill-in response from the customer. In this manner, the data could be easily imported into a customer satisfaction database. The process 916 then terminates at an end state 1110.

In the next state of process 202, the customer selects the type of service to be performed. Again, this may be accomplished in various manners such as a series of selection menus. For example, as process 202 moves to a state 318, a customer selects a general vehicle system to be serviced. In response to this, process 202 moves to a state 322 wherein the service center 110 may query an information storage medium 118, such as a database, and return to the customer a selection of specific components in that system to be serviced. The process 202 then moves to a state 326 wherein the customer selects a specific service required or provides more information on the type of specific service requested. Along with the type of car to be serviced and the type of service to be performed, the system allows the customer to request a geographical area of preference for the service to be performed in. This is illustrated as process 202 moves to a state 330 wherein the customer makes this selection, which may comprise a zip code, an address, a telephone prefix, an area code or any other means of specifically identifying a geographical location. Then the process 202 moves to a state 334 wherein a customer verifies all of the information that has been input and then orders a service cost estimate.

FIG. 4 illustrates a process 206 whereby a service center 110 receives a service estimate request from a customer, extracts information from that order, and generates appropriate SROs to transmit to appropriate service providers. The process 206 moves to a state 402 wherein the service center 110 samples the customer data input into the service estimate request for vehicle information, location information and service type. This is necessary to identify qualified service providers in the area. The process 206 then moves to a state 406 wherein the service center 110 queries an information storage medium 118 to find service providers that match the selection criteria. The process 206 then moves to a state 410 wherein the service center retrieves information regarding the specific layout of the SRO forms required by the service provider terminals 120 of any qualified service providers. This allows the service center 110 to generate and transmit the appropriate SROs for each qualified service provider.

FIG. 5 illustrates a process 210 in which the service center 110 transmits the SROs to the various service providers and monitors the network 102 for the service provider responses. The process 210 moves to a state 502 wherein the service center transmits the SRO to the service provider terminals 120 via an electronic message such as a network connection or an email, or by some other means of transmission, electronic or conventional. The process 210 then moves to a state 506 wherein a timing device, program, routine or other means of keeping time is utilized to track the time since the SRO was transmitted from the service center 110 to the service provider terminals 120. The process 210 then moves to states 510 and 514 wherein if the service provider has provided no response within 48 hours, the service center 110 preferably transmits another SRO. This invention contemplates that other actions may be taken to prompt responses from the service provider such as, but not limited to, telephone calls, email reminders, conventional mail reminders, etc.

FIG. 6 illustrates a process 214 state of an embodiment of the present invention wherein a service provider receives and processes a SRO from the service center 110. The process 214 moves to a state 602 wherein a service provider terminal 120 receives a SRO from a service center 110. The process 214 then moves to a state 606 wherein the service provider terminal queries the SRO fields for data required to perform the estimate. Preferably, the data from the form is used to query a database to return a cost estimate that corresponds to the service requested. Preferably, a service provider can use existing service estimate programs or systems to perform such an operation on the data from the SRO. The system may have its own independent estimate generating system or may utilize a standardized system. The process 214 then moves to a state 616 wherein the service provider terminal 120 takes the returned estimated time for completion as well as the cost of the repair and generates a response for the service center 110. The process 214 then moves to a state 620 wherein the service provider terminal 120 transmits the estimate to the service center 110.

FIG. 7 illustrates a process 218 wherein the service center 110 informs the customer of the receipt of estimates from one or more service providers. The process 218 then moves to a state 702 wherein the service center 110 receives the estimate from the service provider. The response may be an electronic message via a wide area network such as the Internet. The process 218 then moves to a state 706 wherein the service center 110 will query a data storage device for information about the customer for whom the estimate is provided. Process 218 then moves to a state 710 wherein the service center 110 generates a URL address, or some other sort of information storing location, which may be electronic or not, that contains information regarding the estimate and the service provider who provided it. Alternatively, this may be a website on a network such as the WWW or some other public or private network, bulletin board, or similar type addressable network system. Preferably, the location has the capacity to be monitored by the service center 110 to determine if the customer has visited it. The information provided preferably includes a selection mechanism for scheduling maintenance on-line or by more traditional means including, but not limited to, telephone conversations or other similar means. The process 218 then moves to a state 714 wherein the service center 110 returns a motivating mechanism to the customer, such as a discount coupon, along with the estimate, by itself, with information regarding the service provider, or any combination thereof. This information may be delivered via email, telephone message, conventional mail, or any other delivery mechanism.

The process 218 then moves to a state 718 wherein the service center 110 begins monitoring the information storing location to determine if the customer has viewed the information. For conventional mail services, a registered mail receipt verification would be an analogous substitute. Along with this state, the process 218 moves to a state 722 wherein time is measured from when the information is sent to the customer to determine how long it takes the customer to visit the location or site. The process 218 then moves to states 726 and 730 wherein a query occurs to determine if the customer has visited the location or site within a certain predetermined period such as 48 hours. The process 218 moves to a process 222 if the customer has not responded or visited the location within the specified period. These actions are intended to remind the customer of the estimate request and to prompt the customer to visit the location. These actions preferably include creating a specific telephone message for the customer and delivering the message via an automated or manual telephone call. The actions alternatively or concurrently include sending a conventional mail reminder, an email reminder or some other type of notice to the customer.

FIG. 8 illustrates a process 222 wherein the service center 110 reminds the customer that information related to service the customer requested has been provided. The process 222 moves to a state 802 wherein the service center 110 verifies the customer has not visited the location containing the estimate information. The process 222 then moves to a state 806 wherein the service center 110 verifies that the predetermined period has expired since the information was sent to the customer. The process 222 then moves to a state 810 wherein the service center 110 generates a specific message by taking information from the SRO and from stored data regarding the customer. The message may be an automated or manual telephone message to remind the customer of the information that was provided and may be designed to prompt the customer to visit the information location. This message may alternatively be a conventional mail or email message or some other type of notification. The process 222 then moves to a state 814 wherein the message is delivered. Preferably, this entails dialing the customer's telephone and playing a recorded message or delivering a live and spoken message. Preferably, this process is also designed to respond appropriately in the case that an answering machine or a facsimile machine answers the telephone line. Alternatively, the delivery entails delivering whatever electronic media is employed via a public or private network connection.

FIG. 9 illustrates a process 226 wherein a customer selects a service provider and also selects an option provided to schedule the time for the service to take place. The process 226 moves to a state 902 wherein the customer selects a specific service provider. Preferably, this is accomplished by selecting a link in the URL or website provided by the service center 110. Alternatively, this is accomplished by any other means of selecting from a list of service providers such as, but not limited to, telephoning one of the service providers, visiting a service provider's website, or by contacting the service center via e-mail. The process 226 then moves to a state 906 wherein the service center 110 determines if the service provider selected offers on-line or automated scheduling through the service center. A database query or similar data retrieval method, among other means, may accomplish this task. If the service provider does not offer such on-line or automated scheduling then, preferably, the service center 110 provides information to the customer with which the customer may schedule the service with the service provider conventionally over the phone or otherwise. The process 226 then moves to states 910 and 914 wherein the service center retrieves data regarding the service provider from the data storage device 118 by query or similar process and transmits it to the customer. This information may consist of, among other things, a telephone number and an address, and it is transmitted to the customer via the network connection, email, conventional mail or other similar mechanism.

If the service provider does offer automated scheduling, then the process 226 moves to a state 918 and the service center 110 transmits a request for scheduling information related to the specific customer and service requested to the service provider terminal 120. The process 226 then moves to a state 922 wherein the service provider terminal 120 receives a request from the service center 110 and responds, as illustrated below in process states 1002 through 1018 of process 230. The process 226 then moves to a state 926 wherein the service center 110 receives a list of available time slots for appointments or best times to get the service performed. If appointments are not available, the process 226 moves to a state 930 wherein the service center 110 generates and displays a menu including the best times to get this service performed. The process 226 then moves to a state 934 wherein if appointment slots are available, the service center 110 creates and displays to the customer a menu containing such available timeslots for selection. The process 226 then moves to a state 938 wherein the service center 100 receives the customer's selection of a particular time slot. The customer selects the appointment in any number of ways including, but not limited to, selecting a hyperlink in the information location, selecting a menu choice or by entering a selection in an input box. The process 226 then moves to a state 942 wherein the service center 110 generates and displays to the customer a verification of the selected service provider, service type requested, location, and appointment time. The process 226 then moves to a state 946 wherein the service center 110 receives the verification from the customer. Preferably, the verification is the selection of a command button or similar user interface that demonstrates the customer's present intention to confirm the appointment or selection. The process 226 then moves to a state 950 wherein the service center 110 prepares a message containing the verification and appointment information and transmits this message to the service provider terminal 120 via any previously described means. After process states 1022, 1026 and 1030 described in FIG. 10 below are complete, the process 226 moves to a state 954 wherein the service center 110 receives a confirmation of the appointment from the service provider terminal 120 and transmits such confirmation to the customer.

FIG. 10 illustrates a process 230 whereby a service provider schedules an appointment for services with a customer via the service center 110. The process 230 moves to a state 1002 wherein the service provider terminal 120 receives a request for scheduling information from the service center 110. The process 230 then moves to a state 1006 wherein the service provider terminal 120 queries the data storage device 128 for scheduling information regarding the service described in the SRO. The process 230 then moves to a state 1010 wherein the service provider terminal retrieves a value that indicates how difficult this service is, how long it will take, and what parts need to be ordered including their lead times. Next, the process 230 moves to a state 1014 wherein the service provider terminal 120 locates the earliest available timeslots for work corresponding to this value. The service provider terminal 120 may also provide a plurality of other times available for scheduling of this service from which the customer may choose. The process 230 then moves to a state 1018 wherein the service provider terminal 120 transmits the times available to the service center 110. Through process 226 states 934 and 938, described in FIG. 9, the service center 110 provides a selection menu for the customer, who then selects a time for the service to take place. The process 230 then moves to a state 1022 wherein the service provider terminal 120 receives the time selection and customer verification from the service center 110. The process 230 then moves to a state 1026 wherein the service provider terminal updates a service provider service scheduling system with the appointment requested by this customer. The service scheduling system may comprise any number of means for scheduling appointments including electronic calendar systems. The process 230 then moves to a state 1030 wherein the service provider terminal 120 generates a confirmation of the scheduled appointment and transmits that confirmation with any associated designation to the service center 110.

FIG. 11 illustrates a process 234 wherein the service center 110 generates customer service and satisfaction survey and transmits that survey to the customer. The process 234 moves to a state 1102 wherein the service center 110 utilizes information from the SRO and the service provider confirmation, as well as any other pertinent information, to generate a survey. Preferably, the survey is developed to determine the quality of the service the customer received and allows the customer to provide feedback and criticism of the service providing system. The process 234 then moves to a state 1106 wherein the service center 110 delivers the survey to the customer via any of several means available including, by way of example and not limitation, email, conventional mail, telephone interview, automated telephone message.

This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. An online system for ordering vehicle services, comprising:
an input module adapted to receive a service request order from a customer;
a processing module adapted to determine a plurality of service businesses that are geographically near the customer;
a transmission module adapted to electronically transmit the service request order to the plurality of service businesses; and
an estimation module adapted to receive service estimates from the plurality of service businesses.

2. The system of claim 1, wherein the input module comprises a Hypertext Markup Language (HTML) form running in an Internet browser.

3. The system of claim 1, wherein the service request order comprises a make, model and year of an automobile.

4. The system of claim 1, wherein the processing module resides on an Internet server.

5. The system of claim 1, wherein the plurality of service businesses are determined by gathering service businesses with the same zip code as the customer.

6. The system of claim 1, wherein the transmission module is adapted to send the service request order across the Internet.

7. The system of claim 6, wherein the transmission request module is adapted to send the service request order as a structured document.

8. The system of claim 7, wherein the structured document is an Extensible Markup Language (XML) document.

9. The system of claim 1, comprising a page preparation module adapted to generate a Hypertext Markup Language (HTML) page comprising the service estimates from the plurality of service businesses.

10. The system of claim 9, wherein the page preparation module comprises instructions for electronically sending the customer a link to the generated HTML page.

11. The system of claim 10, comprising a telephone reminder module adapted to telephonically contact the customer if the generated HTML page is not viewed within a predetermined time period.

12. A method for electronically ordering vehicle services, comprising:
receiving a service request order from a customer;
determining a plurality of service businesses that are geographically near the customer;
electronically transmitting the service request order to the plurality of service businesses; and
receiving service estimates from the plurality of service businesses.

13. The method of claim 12, wherein receiving the service request order comprises receiving a Hypertext Markup Language (HTML) form.

14. The method of claim 12, wherein the service request order comprises a make, model and year of an automobile.

15. The method of claim 12, wherein the service request order is received by an Internet server.

16. The method of claim 12, wherein the plurality of service businesses are determined by gathering service businesses with the same zip code as the customer.

17. The method of claim 12, wherein electronically transmitting the service request order comprises transmitting the service request order across the Internet.

18. The method of claim 17, wherein electronically transmitting the service request module comprises transmitting a structured document.

19. The method of claim 18, wherein the structured document is an Extensible Markup Language (XML) document.

20. The method of claim 12, comprising generating a Hypertext Markup Language (HTML) page comprising the service estimates from the plurality of service businesses.

21. The method of claim 20, comprising electronically sending the customer a link to the generated HTML page.

22. The method of claim 21, comprising telephonically contacting the customer if the generated HTML page is not viewed within a predetermined time period.
